(19) United States
(12) Patent Application Publication
(10) Pub. No.: US 2014/0030520 A1
(43) Pub. Date: Jan. 30, 2014

(54) HALOGEN-FREE FLAME-RETARDANT POLYMER COMPOSITION, INSULATED ELECTRIC WIRE, AND CABLE

(71) Applicant: Hitachi Metals, Ltd., Tokyo (JP)

(72) Inventors: YOSHIAKI NAKAMURA, Hitachi (JP); Motoharu Kajiyama, Takahagi (JP); Kentaro Segawa, Hitachi (JP); Kenichiro Fujimoto, Hitachi (JP); Hitoshi Kimura, Hitachi (JP)

(73) Assignee: Hitachi Metals, Ltd., Tokyo (JP)

(21) Appl. No.: 13/949,181

(22) Filed: Jul. 23, 2013

(30) Foreign Application Priority Data
Jul. 25, 2012 (JP) 2012-164883

(51) Int. Cl. H01B 3/30

(52) U.S. Cl. CPC H01B 3/308
USPC 428/368; 524/436

(57) ABSTRACT

A halogen free flame-retardant polymer composition includes flame retardancy and excellent oil resistance/fuel resistance, low-temperature characteristics, and injury resistance, and an insulated electric wire and a cable include the composition. The halogen-free flame-retardant polymer composition includes a base polymer including 60 to 70% by mass of LLDPE, 10% by mass or more of EVA having a melt flow rate (MFR) of 100 or more, and 10 to 20% by mass of maleic acid-modified polyolefin, a metal hydroxide added at a ratio of 150 to 220 parts by mass relative to 100 parts by mass of the base polymer, and carbon black. The addition ratio (metal hydroxide/carbon black) between the metal hydroxide and the carbon black is 15:1 to 100:1.

The present application is based on Japanese patent application No. 2012-164883 filed on Jul. 25, 2012, the entire contents of which are incorporated herein by reference.

### BACKGROUND OF THE INVENTION

1. Field of the Invention

The present invention relates to a halogen-free flame-retardant polymer composition, an insulated electric wire, and a cable. In further detail, the present invention relates to a halogen-free flame-retardant polymer composition, an insulated electric wire, and a cable which may be used for railway vehicles, automobiles, electric/electronic apparatuses, etc., the polymer composition being excellent in flame retardancy/low toxic gas emission during combustion, oil resistance/fuel resistance, and low temperature characteristics.

2. Description of the Related Art

Materials used for insulated electric wires and cables used in railway vehicles, automobiles, electric/electronic apparatuses, etc. are excellent in balance between oil resistance/fuel resistance, low-temperature characteristics, flame retardancy, and cost. These materials are each prepared by adding, in order to enhance flame retardancy, a halogen-based flame retardant to a polyvinyl chloride (PVC) composition, a chloroprene rubber composition, a chlorosulfonated polyethylene composition, a chlorinated polyethylene composition, fluorocarbon rubber, a fluorocarbon polymer, a polyolefin polymer such as polyethylene, or the like. However, the materials containing large amounts of halogens produce large amounts of toxic and harmful gases during combustion and also produce highly toxic dioxin depending on burning conditions. Therefore, insulated electric wires and cables using halogen-free materials, which do not contain halogen substances, as coating materials have begun to be popularized from the viewpoint of fire safety and reduction in loads on the environment.

However, halogen-free materials tend to have low flame retardancy, oil resistance, oil resistance/fuel resistance, and low-temperature characteristics as compared with general halogen-containing materials due to differences between chemical structures of base polymers and between flame-retardant function mechanisms.

In particular, insulated electric wires and cables used in railway vehicles have the probability of causing a tragedy due to failures thereof and are thus required to use halogen-free materials having high flame retardancy, oil resistance/fuel resistance, and low-temperature characteristics at −40° C. according to the standards (EN50264, 50306, etc.).

In order to enhance flame retardancy of halogen-free materials, it is proposed that a polymer side chain is provided with a structure which generates incombustible gas during combustion or a halogen-free flame retardant such as a metal hydroxide, a nitrogen compound, or the like is added (refer to Japanese Patent No. 4629836 and Japanese Unexamined Patent Application Publication Nos. 2002-42575 and 2006-89603).

However, providing a polymer side chain with a structure which generates incombustible gas leads to an increase in polarity of the polymer, degrading low-temperature characteristics. Also, providing a side chain with a functional group inhibits crystallization of a polymer and produces a soft material, thereby causing the probability of short-circuits in particularly thin insulated electric wires and cables due to injuries. In addition, when a halogen-free flame retardant is added, the flame retardant is required to be added in a large amount, thereby causing the problem of significantly degrading mechanical properties not only at a low temperature but also at room temperature.

The oil resistance/fuel resistance can be improved by increasing the crystallinity or polarity of a polymer. However, a material having increased polymer crystallinity is significantly degraded to impair flame retardancy, because the material cannot be added a large amount of flame retardant. Further a polymer having higher polarity has the disadvantage of poor low-temperature characteristics and injury resistance as described above.

Japanese Unexamined Patent Application Publication No. 2006-89603 proposes an insulated electric wire which includes, as a base polymer, an ethylene-vinyl acetate copolymer having high polymer polarity and which has high flame retardancy and is improved in disadvantages such as low-temperature characteristics and injury resistance. However, the insulated electric wire cannot satisfy the strict conditions (EN50306) required for application to railway vehicles and has unsatisfactory low-temperature characteristics and injury resistance.

### SUMMARY OF THE INVENTION

In view of the foregoing and other exemplary problems, drawbacks, and disadvantages of the conventional methods and structures, and an exemplary feature of the present invention is to provide halogen-free flame-retardant polymer composition, insulated electric wire, and cable. It is an object of the present invention to provide a halogen-free flame-retardant polymer composition having flame retardancy and excellent oil resistance/fuel resistance, low-temperature characteristics, and injury resistance, and also provide an insulated electric wire and a cable.

The inventors conducted various investigations with attention to the type and ratio of a base polymer and the ratios of metal hydroxide and carbon black added. As a result, the present invention described below has been achieved.

[1] According to one exemplary aspect of the invention, a halogen-free flame-retardant polymer composition including a base polymer, a metal hydroxide added at a ratio of 150 to 220 parts by mass relative to 100 parts by mass of the base polymer, and carbon black, the base polymer including 60% to 70% by mass of linear low-density polyethylene (LLDPE), 10% by mass or more of ethylene-vinyl acetate (EVA) having a melt flow rate (MFR) of 100 or more, and 10% to 20% by mass of a maleic acid-modified polyolefin, wherein the ratio (metal hydroxide/carbon black) between the metal hydroxide and the carbon black added is 15:1 to 100:1.

[2] In the above exemplary invention [1] many exemplary modifications and changes can be made as below (the following exemplary modifications and changes can be made). The halogen-free flame-retardant polymer composition described above in [1], wherein the LLDPE has a MFR of 1.0 to 1.5 and a density of 0.915 g/cm³ to 0.923 g/cm³.

[3] According to another exemplary aspect of the invention, an insulated electric wire including a conductor and an insulating layer formed on the periphery of the conductor and includes the halogen-free flame-retardant polymer composition described above in [1].

[4] According to another exemplary aspect of the invention, a cable including a conductor, an insulating layer formed on the periphery of the conductor, and a sheath formed on the periphery of the insulating layer and includes the halogen-free flame-retardant polymer composition described above in [1].

The above exemplary modifications may be alone or in any combination thereof.

According to the present invention, it is possible to provide a halogen-free flame-retardant polymer composition having flame retardancy and excellent oil resistance/fuel resistance, low-temperature characteristics, and injury resistance, and also provide an insulated electric wire and a cable.

### BRIEF DESCRIPTION OF THE DRAWINGS

The foregoing and other exemplary purposes, aspects and advantages will be better understood from the following detailed description of the invention with reference to the drawings, in which:

FIG. 1 is a sectional view illustrating an insulated electric wire according to an embodiment of an exemplary aspect of the present invention.

FIG. 2 is a sectional view illustrating a cable according to an embodiment of an exemplary aspect of the present invention.

### DESCRIPTION OF THE EXEMPLARY EMBODIMENTS

### Summary of Embodiments

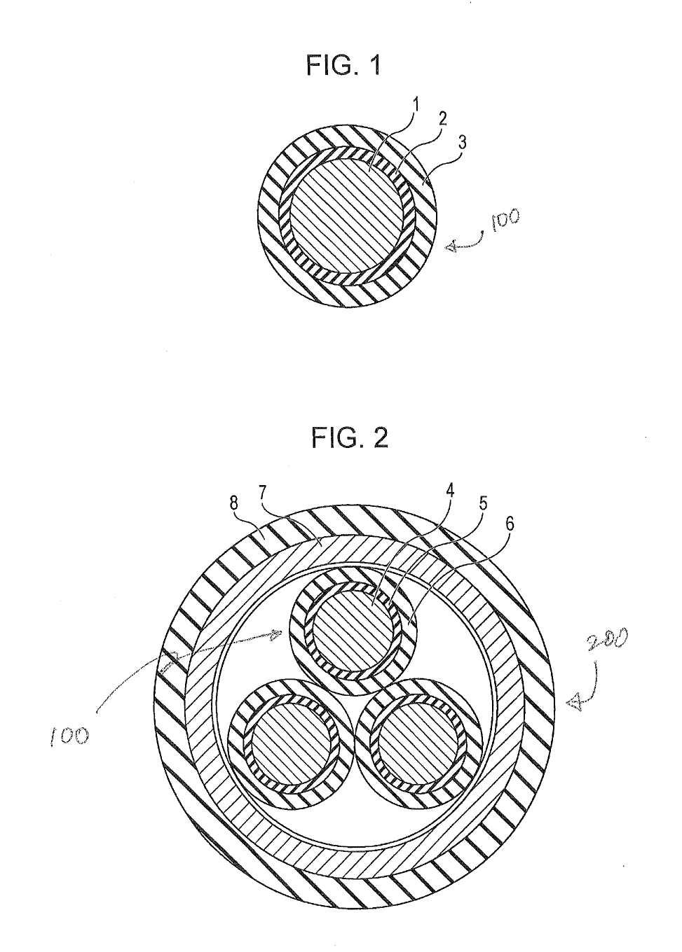

Referring now to the drawings, and more particularly to FIGS. 1-2, there are shown exemplary embodiments of an exemplary aspect of the methods and structures according to the present invention.

Although the invention has been described with respect to specific exemplary embodiments for complete and clear disclosure, the appended claims are not to be thus limited but are to be construed as embodying all modifications and alternative constructions that may occur to one skilled in the art which fairly fall within the basic teaching herein set forth.

Further, it is noted that Applicant's intent is to encompass equivalents of all claim elements, even if amended later during prosection.

A halogen-free flame-retardant polymer composition according to an embodiment of the present invention includes a base polymer and a metal hydroxide added as a halogen-free flame retardant to the base polymer, the base polymer containing 60 to 70% by mass of LLDPE, 10% by mass or more of EVA having a melt flow rate (MFR) of 100 or more, and 10 to 20% by mass of a maleic acid-modified polyolefin, the metal hydroxide being added at a ratio of 150 to 220 parts by mass relative to 100 parts by mass of the base polymer, and carbon black being further added. The ratio (metal hydroxide/carbon black) between the metal hydroxide and carbon black added is 15:1 to 100:1.

A halogen-free flame-retardant polymer composition, an insulated electric wire, and a cable according to embodiments of an exemplary aspect of the present invention are described in detail below.

### [Halogen-Free Flame-Retardant Polymer Composition]

A halogen-free flame-retardant polymer composition according to an embodiment of an exemplary aspect of the present invention includes a base polymer, a metal hydroxide added at a ratio of 150 to 220 parts by mass relative to 100 parts by mass of the base polymer, and carbon black, the base polymer containing 60% to 70% by mass of LLDPE, 10% by mass or more of EVA having a melt flow rate (MFR) of 100 or more, and 10% to 20% by mass of a maleic acid-modified polyolefin. The ratio (metal hydroxide/carbon black) between the metal hydroxide and carbon black added is 15:1 to 100:1.

LLDPE constituting the base polymer represents linear low-density polyethylene specified by JIS K 6899-1:2000. As described above, in order to impart such high oil resistance/fuel resistance and injury resistance that can be used in application to railway vehicles, it is necessary to use a crystalline polymer. In addition, “oil resistance” represents resistance to ASTM No. 2 oil, and “fuel resistance” represents resistance to ASTM No. 3 oil. Among crystalline polymers, both polypropylene and high-density polyethylene are undesired because polypropylene is degraded by electron beams and is thus difficult to cross-link and is unsatisfactory in heat resistance, and high-density polyethylene becomes unsatisfactory in mechanical properties, particularly tensile properties, when a large amount of a metal hydroxide is added to impart flame retardancy. In comparison with low-density polyethylene (LDPE), LLDPE having a uniform molecular weight distribution and a high crystal melting temperature is suitable.

As described above, the content of LLDPE may be 60% to 70% by mass. With a content of less than 60% by mass, oil resistance/fuel resistance and injury resistance become unsatisfactory, while with a content exceeding 70% by mass, the low-temperature characteristics and tear characteristics become unsatisfactory when 150 parts by mass or more of the metal hydroxide is added.

In the embodiment of an exemplary aspect of the present invention, in order to impart high flame retardancy to the composition, the metal hydroxide may be added at a ratio of 150 to 220 parts by mass relative to 100 parts by mass of the base polymer. However, when a large amount of the metal hydroxide is added, the base polymer containing LLDPE alone has unsatisfactory tear characteristics and further cannot satisfy tensile characteristics at a low temperature. Further, an antioxidant added for imparting heat resistance easily bleed-out.

Therefore, in the embodiment, the base polymer may contain, in addition to LLDPE, 10% by mass or more of EVA having an MFR (melt flow rate, JIS K 7210, 190° C., 2.16 kg load) of 100 or more and 10% to 20% by mass of maleic acid-modified polyolefin, so that the tear characteristics and low-temperature tensile characteristics can be improved, and bleed-out can be suppressed.

Slippage between the metal hydroxide and the polymer may be improved by adding 10% by mass or more of EVA having an MFR of 100 or more to LLDPE, and thus the tear characteristics can be improved. When the amount of EVA added is less than 10% by mass, the improving effect cannot be achieved.

As described above, EVA having an MFR of 100 or more is allowed to function as wax to satisfy the tear characteristics. This effect is not induced by using EVA having a MFR of less than 100. The polarity of the polymer can be increased by adding EVA, and affinity for a compounding agent with polarity, such as an antioxidant or the like, can be enhanced, thereby suppressing bleed-out.

When the base polymer further contains 10 to 20% by mass of maleic acid-modified polyolefin, adhesion between the polymer and the metal hydroxide can be enhanced to improve the low-temperature characteristics. Maleic acid modification used in the embodiment represents grafting the polyolefin with maleic anhydride or a copolymer of the polyolefin with maleic anhydride. Examples of the polyolefin include natural rubber butyl rubber, ethylene-propylene rubber, ethylene-a-olefin copolymers, styrene-butadiene rubber, nitrile rubber, acryl rubber, silicone rubber, urethane rubber, polyethylene, polypropylene, ethylene-vinyl acetate copolymers, polyvinyl acetate, ethylene-ethyl acrylate copolymers, ethylene-acrylic acid ester copolymers, polyurethane, and the like. In particular, ethylene-propylene rubber, ethylene-α-olefin copolymers, and ethylene-ethyl acrylate copolymers are exemplary. When the amount of the maleic acid-modified polyolefin is less than 10% by mass, the effect is not produced, while when the amount exceeds 20% by mass, adhesion is excessively increased, thereby decreasing the initial tensile characteristics, particularly breaking elongation.

In the embodiment, the base polymer may contain a polymer, for example, an ethylene-a-olefin copolymer or the like, other than LLDPE, EVA, and the maleic acid-modified polyolefin as long as the advantages of the present invention are exhibited.

Further, in the embodiment, the metal hydroxide may be added at a ratio of 150 to 220 parts by mass relative to 100 parts by mass of the base polymer, and carbon black may be further added so that the ratio (metal hydroxide/carbon black) between the metal hydroxide and carbon black added is 15:1 to 100:1, thereby achieving the composition having such high flame retardancy that can be used for an insulated electric wire and cable in application to railway vehicles.

The type of the metal hydroxide used in the embodiment is not particularly limited, but aluminum hydroxide and magnesium hydroxide having a high flame retardant effect are exemplary, and the metal hydroxide surface-treated with an organosilane coupling agent and/or a fatty acid or a titanate-based coupling agent is more exemplary used.

The type of carbon black is not particularly limited, but FT- and MT-grade carbon is exemplary in view of breaking elongation and the like. In order to secure predetermined flame retardancy, a large amount of the metal hydroxide may be added as a flame retardant. However, mechanical properties of the composition are impaired by adding a large amount of the metal hydroxide. Therefore, as a result of intensive research of an addition ratio to carbon black used as a flame retardant aid, high flame retardancy is exhibited at a ratio (metal hydroxide/carbon black) of 15:1 to 100:1 between the metal hydroxide and carbon black. When the amount of the metal hydroxide is less than 150 parts by mass, predetermined flame retardancy cannot be satisfied, while when the amount exceeds 220 parts by mass, mechanical properties cannot be satisfied. With respect to the ratio of the carbon black added, the carbon black added at a ratio less than 100:1 causes no improvement in flame retardancy, while addition at a ratio higher than 15:1 results in an increase in total amount of carbon black, thereby failing to satisfy the mechanical properties.

In order to maintain the metal hydroxide and carbon black added in a good dispersion state, the LLDPE used may have a MFR of 1.0 to 1.5 and a density of 0.915 g/cm³ to 0.923 g/cm³.

In the embodiment, the above-described composition can be made usable instantaneously in a high temperature by cross-linking with electron beams. The amount of irradiating electron beams may be 70 kGy to 90 kGy. An amount of less than 70 kGy may cause insufficient cross-linking, and an amount exceeding 90 kGy may cause excessive cross-linking and unsatisfactory initial tensile characteristics. Another cross-linking method other than electron beam irradiation can be used as long as injury resistance as an advantage of the present invention can be exhibited.

According to demand, it is exemplary to add to the composition of the embodiment, additives such as an antioxidant, a silane coupling agent, a flame retardant/flame retardant aid (for example, a hydroxystannate, calcium borate, a phosphorus-based flame retardant such as ammonium polyphosphate, red phosphorus, phosphoric acid ester, or the like, a silicone-based flame retardant such as polysiloxane or the like, a nitrogen-based flame retardant such as melamine cyanurate, a cyanuric acid derivative, or the like, a boric acid compound such as zinc borate or the like, a molybdenum compound, or the like), a cross-linking agent, a cross-linking acid, a cross-linking promoter, a lubricant, a surfactant, a softener, a plasticizer, an inorganic filler, carbon black, a compatibilizer, a stabilizer, a metal chelating agent, a ultraviolet absorber, a photostabilizer, a colorant, and the like.

### [Insulated Electric Wire]

An insulated electric wire according to an embodiment of the present invention includes a conductor includes a general-purpose material, and an insulating layer formed on the periphery of the conductor and includes the above-described halogen-free flame-retardant polymer composition.

The insulating layer has a two-layer structure including an inner layer and an outer layer, and the inner layer exemplarily uses a composition which contains a composition of ethylene-a-olefin copolymers including high-density polyethylene (HDPE) or LLDPE and very low-density polyethylene (VLDPE) and which is cross-linked by silane water-cross-linking or electron beam irradiation. This configuration can produce, for example, an insulated electric wire for application to railway vehicles, particularly an electric wire satisfying EN50264-3-1.

That is, the halogen-free flame-retardant polymer composition constituting the outer layer of the insulating layer includes EVA and a large amount of the metal hydroxide, leaving an anxiety about electric insulation, but the material of the inner layer includes the composition of ethylene-a-olefin copolymers including HDPE or LLDPE and VLDPE without containing EVA. Thus, the inner layer material can maintain electric insulation, and the outer layer material can maintain flame retardancy. Regardless of whether the ethylene-a-olefin copolymers are modified with maleic anhydride, combination with a maleic anhydride-modified polymer exhibits excellent electric characteristics, and the maleic anhydride-modified polymer may be such a polyolefin as described above, not an ethylene-a-olefin copolymer. The ratio between the thicknesses of the inner and outer layers is not particularly limited, but the ratio of thickness (inner layer/outer layer) may be 1:1 to 1:6.

According to demand, it is exemplary to add, to the inner layer material, additives such as an antioxidant, a silane coupling agent including silicone gum, a flame retardant/flame retardant aid, a cross-linking agent, a cross-linking acid, a cross-linking promoter, a hydrolysis inhibitor (for example, a polycarbodiimide compound), a lubricant (for example, a fatty acid metal salt or an amide-based lubricant), a softener, a plasticizer, an inorganic filler, carbon black, a compatibilizer, a stabilizer, a metal chelating agent, a ultraviolet absorber, a photostabilizer, a colorant, and the like. However, when an additive adversely affecting electric characteristics, particularly a metal hydroxide, is used as the flame retardant, the adding amount may be 200 parts by mass or less, preferably 150 parts by mass or less. In addition, in order to maintain injury resistance, particularly penetration resistance, like the insulating outer layer, the inner layer is exemplarily cross-linked with electron beams.

### [Cable]

A cable according to an embodiment of the present invention includes a conductor, an insulating layer formed on the periphery of the conductor, and a sheath formed on the periphery of the insulating layer and composed of the above-described halogen-free flame-retardant polymer composition. Specifically, the conductor includes a general-purpose material, the insulating layer includes, for example, at least one polymer selected from the group consisting of polybutylene naphthalate, polybutylene terephthalate, polyphenylene oxide, and polyether ether ketone, and the above-described halogen-free flame-retardant polymer composition is formed as a sheath material on the periphery of the insulating layer. Consequently, a control cable for application to railway vehicles, particularly satisfying EN50306-3, can be formed. As described above, since engineer plastic having excellent electric insulation and high rigidity is used for the insulating layer, the cable has excellent direct-current stability and injury resistance, particularly, wear resistance.

The insulating layer may include at least one polymer selected from the group consisting of polybutylene naphthalate, polybutylene terephthalate, polyphenylene oxide, and polyether ether ketone, for example, contains a composition of polybutylene naphthalate and polybutylene terephthalate or has a two-layer structure including an insulator outer layer which contains a composition of polybutylene naphthalate and polybutylene terephthalate and an insulator inner layer which contains polyphenylene oxide. The polybutylene naphthalate and polybutylene terephthalate may contain a crystal phase (hard segment) and an amorphous phase (soft segment), for example, an elastomer which is a copolymer with polyether. According to demand, it is exemplary to add to at least one polymer used for the insulating layer, additives such as an antioxidant, a silane coupling agent, a flame retardant/flame retardant aid, a cross-linking agent, a cross-linking acid, a cross-linking promoter, a hydrolysis inhibitor (for example, a polycarbodiimide compound), a lubricant (for example, a fatty acid metal salt or an amide based lubricant), a softener, a plasticizer, an inorganic filler, carbon black, a compatibilizer, a stabilizer, a metal chelating agent, a ultraviolet absorber, a photostabilizer, a colorant, and the like.

### EXAMPLES

The halogen-free flame-retardant polymer composition, the insulated electric wire, and the cable of the present invention are described in further detail below with reference to examples. The present invention is not limited to the examples below.

An insulated electric wire and cable were formed as described below using a halogen-free flame-retardant polymer composition. That is, as shown in FIG. 1, the insulated electric wire 100 was formed by coating the periphery of each of a plurality of tinned-copper (e.g. tin-plated copper) conductors 1 with an insulator inner layer 2 and an insulator outer layer 3. In addition, as shown in FIG. 2, the cable 200 was formed by twisting together three insulated electric wires 100, which were formed by coating the periphery of each of a plurality of tin-plated copper conductors 4 with an insulator inner layer 5 and an insulator outer layer 6, covering the wires 100 with a metal braid 7, and then coating the braid 7 with a sheath 8. The insulation inner layer 2, used often outer layer 3, used often inner layer 5, used often outer layer 6 and sheath 8 may all include the composition according to the claimed invention.

### (Halogen-Free Flame-Retardant Polymer Composition)

A halogen-free flame-retardant polymer composition was produced to have each of compositions of Examples 1 to 9 shown in Table 1 and compositions of Comparative Examples 1 to 10 shown in Table 4. That is, the composition materials shown in Tables 1 and 4 were kneaded with a pressure kneader, extruded into a strand, cooled, and then pelletized.

### (Insulated Electric Wire)

An insulated electric wire having the two-layer structure insulator including inner and outer layers was produced. That is, an inner layer composition of the insulator shown in Table 2 was kneaded with a pressure kneader, extruded into a strand, cooled, and then pelletized. For an outer layer composition of the insulator, a pellet-shaped halogen-free flame-retardant polymer composition produced in each of Examples 1 to 9 and Comparative Examples 1 to 10 was used.

A 0.75SQ tinned-copper conductor was coated with the kneaded inner and outer layer materials of the insulator by two-layer simultaneous extrusion so that the thickness of the inner layer was 0.2 mm, and the thickness of the outer layer was 0.5 mm, and then cross-linked by irradiation with electron beams of 70 kGy, forming an insulated electric wire.

### (Cable)

A cable provided with a two-layer structure insulator including inner and outer layers and a sheath using the halogen-free flame-retardant polymer composition produced in each of Examples 1 to 9 and Comparative Examples 1 to 10 was produced.

A 2.5SQ tinned-copper conductor was coated with the composition materials shown in Table 3 for the inner and outer layers of the insulator by two-layer simultaneous extrusion so that the thickness of the inner layer was 0.15 mm, and the thickness of the outer layer was 0.25 mm, forming an insulated electric wire. Three insulated electric wires were twisted together, covered with a metal braid, coated with the sheath composition material of 0.6 mm in thickness by extrusion, and then irradiated with electron beams of 70 kGy to cross-link the sheath material, forming a cable.

TABLE 1
(parts by weight)

| | | Example 1 | Example 2 | Example 3 | Example 4 | Example 5 | Example 6 | Example 7 | Example 8 | Example 9 |
|---|---|---|---|---|---|---|---|---|---|---|
| Base polymer | LLDPE (1) | 60 | 70 | 60 | 70 | 70 | 70 | 70 | — | — |
| | LLDPE (2) | — | — | — | — | — | — | — | 70 | — |
| | LLDPE (3) | — | — | — | — | — | — | — | — | 70 |
| | EVA(1) | 30 | 20 | 20 | 10 | 10 | 10 | 10 | 10 | 10 |
| | Maleic acid- | 10 | 10 | 20 | 20 | 20 | 20 | 20 | 20 | 20 |
| | modified | | | | | | | | | |
| | polyolefin | | | | | | | | | |
| | (1) | | | | | | | | | |
| Metal | Magnesium | 200 | 200 | 200 | 200 | 180 | 220 | 150 | 200 | 200 |
| hydroxide | hydroxide | | | | | | | | | |
| Carbon black | FT carbon | 2 | 2 | 2 | 2 | 10 | 2.5 | 10 | 2 | 2 |
| Cross-linking | TMPT | 2 | 2 | 2 | 2 | 2 | 2 | 2 | 2 | 2 |
| aid | | | | | | | | | | |
| Antioxidant | Composite | 1 | 1 | 1 | 1 | 1 | 1 | 1 | 1 | 1 |
| | antioxidant | | | | | | | | | |
| Antioxidant | Phenolic | 2 | 2 | 2 | 2 | 2 | 2 | 2 | 2 | 2 |
| | antioxidant | | | | | | | | | |
| Lubricant | Zinc stearate | 1 | 1 | 1 | 1 | 1 | 1 | 1 | 1 | 1 |

| | | | | | | | | | |
|---|---|---|---|---|---|---|---|---|---|
| Total | 308 | 308 | 308 | 308 | 296 | 328.5 | 266 | 308 | 308 |
| Metal hydroxide:carbon black | 100:1 | 100:1 | 100:1 | 100:1 | 18:1 | 88:1 | 15:1 | 100:1 | 100:1 |

LLDPE (1): Evolue SP1510 ® (Prime Polymer) MFR = 1.0 ρ = 0.915
LLDPE (2): Evolue SP2510 ®(Prime Polymer) MFR = 1.5 ρ = 0.923
LLDPE (3): Neo-zex 0134M ®(Prime Polymer) MFR = 1.2 ρ = 0.921
EVA (1): Evaflex 45X ®(Mitsui Du-Pont Polychemicals) VA amount = 46% MFR = 100
Maleic acid-modified polyolefin (1): Tafmer MH5040 ® (Mitsui Chemicals)
Magnesium hydroxide: MAGSEEDS S4 ® (Konoshima Kagaku Co., Ltd.)
TMPT: trimethylolpropane trimethacrylate
Composite antioxidant: AO-18 ® (ADEKA)
Phenolic antioxidant: Irganox 1010 ® (BASF)

TABLE 2

| | | (parts by weight) |
|---|---|---|
| Base polymer | LLDPE (1) | 70 |
| Base polymer | Ethylene-α-olefin | 25 |
| Base polymer | Maleic acid-modified | 5 |
| | polyolefin (2) | |
| Filler | Organosilane-treated fired | 100 |
| | clay | |
| Cross-linking aid | TMPT | 1 |
| Antioxidant | Composite antioxidant | 1.5 |
| Lubricant | Zinc stearate | 0.5 |

| | |
|---|---|
| Total | 203 |

LLDPE (1): Evolue SP1510 ® (Prime Polymer) MFR = 1.0 ρ = 0.915
Ethylene-α-olefin: Tafmer A4085 ® (Mitsui Chemicals)
Maleic acid-modified polyolefin (2): Bondine LX4110 ®
Organosilane-treated fired clay: Translink 37 ® (Engelhard)
TMPT: trimethylolpropane trimethacrylate
Composite antioxidant: AO-18 ® (ADEKA)

TABLE 3

| | |
|---|---|
| Outer layer | PBN |
| Inner layer | PPO |

TABLE 4
(parts by weight)

| | | | | | | | | | | | Comp. |
|---|---|---|---|---|---|---|---|---|---|---|---|
| | | Comp. | Comp. | Comp. | Comp. | Comp. | Comp. | Comp. | Comp. | Comp. | Example |
| | | Example 1 | Example 2 | Example 3 | Example 4 | Example 5 | Example 6 | Example 7 | Example 8 | Example 9 | 10 |
| Base polymer | LLDPE (1) | — | 50 | 80 | 70 | 60 | 60 | 60 | 60 | 60 | 60 |
| | HDPE | 60 | — | — | — | — | — | — | | — | — |
| | EVA (1) | 30 | 30 | 10 | 5 | 35 | — | 30 | 30 | 30 | 30 |
| | EVA (2) | — | — | — | — | — | 30 | — | — | — | — |
| | Maleic acid- | 10 | 20 | 10 | 25 | 5 | 10 | 10 | 10 | 10 | 10 |
| | modified | | | | | | | | | | |
| | polyolefin | | | | | | | | | | |
| | (1) | | | | | | | | | | |
| Metal | Magnesium | 200 | 200 | 150 | 200 | 200 | 200 | 140 | 230 | 200 | 200 |
| hydroxide | hydroxide | | | | | | | | | | |
| Carbon black | FT carbon | 2 | 2 | 2 | 2 | 2 | 2 | 2 | 10 | 1 | 15 |
| Cross-linking | TMPT | 2 | 2 | 2 | 2 | 2 | 2 | 2 | 2 | 2 | 2 |
| aid | | | | | | | | | | | |
| Antioxidant | Composite | 1 | 1 | 1 | 1 | 1 | 1 | 1 | 1 | 1 | 1 |
| | antioxidant | | | | | | | | | | |
| Antioxidant | Phenolic | 2 | 2 | 2 | 2 | 2 | 2 | 2 | 2 | 2 | 2 |
| | antioxidant | | | | | | | | | | |
| Lubricant | Zinc stearate | 1 | 1 | 1 | 1 | 1 | 1 | 1 | 1 | 1 | 1 |

| | | | | | | | | | | |
|---|---|---|---|---|---|---|---|---|---|---|
| Total | 308 | 308 | 258 | 308 | 308 | 308 | 248 | 346 | 307 | 321 |
| Metal hydroxide: carbon black | 100:1 | 100:1 | 75:1 | 100:1 | 100:1 | 100:1 | 70:1 | 23:1 | 200:1 | 13.3:1 |

LLDPE (1): Evolue SP1510 ® (Prime Polymer) MFR = 1.0 ρ = 0.915
EVA (1): Evaflex 45X ® (Mitsui Du-Pont Polychemicals) VA amount = 46% MFR = 100
EVA (2): Evaflex 45LX ® (Mitsui Du-Pont Polychemicals) VA amount = 46% MFR = 2.5
Maleic acid-modified polyolefin (1): Tafmer MH5040 ® (Mitsui Chemicals)
Magnesium hydroxide: MAGSEEDS S4 ® (Konoshima Kagaku Co., Ltd.)
TMPT: trimethylolpropane trimethacrylate
Composite antioxidant: AO-18 ® (ADEKA)
Phenolic antioxidant: Irganox 1010 ® (BASF)

### (Evaluation Method)

Each of the insulated electric wires was evaluated according to EN50264-3-1. The insulated electric wire satisfying all standards was evaluated as “Pass”.

Each of the cables was evaluated according to EN50306-3 and 4. The cable satisfying all standards was evaluated as “Pass”.

### [Initial Tensile Test]

The sheath material was peeled from each of the cables and punched with a No. 6 dumbbell described in JIS K6251, and a test sample punched out was stretched at a rate of 200 mm/min using a tensile tester to measure tensile strength and breaking elongation. The test sample having a tensile strength of 10 MPa or more and a breaking elongation of 150% or more was evaluated as “Pass”. With respect to the tube, the tensile test was performed using a tube shape formed by removing the conductor, but description is omitted because of the same results.

### [Oil Resistance Test]

Like in the initial tensile test, the sheath material was peeled from each of the cables and punched with a No. 6 dumbbell. A test sample punched out was immersed in ASTM No. 2 oil at 100° C. for 72 hours. After immersion, the test sample was stretched at a rate of 200 mm/min using a tensile tester to measure tensile strength and breaking elongation. The test sample having a retention of tensile strength falling in a range of 70% to 130% and a retention of breaking elongation falling in a range of 60% to 140% based on the results of the initial tensile test was evaluated as “Pass”.

### [Fuel Resistance Test]

Like in the initial tensile test, the sheath material was peeled from each of the cables and punched with a No. 6 dumbbell. A test sample punched out was immersed in ASTM No. 3 oil at 100° C. for 168 hours. After immersion, the test sample was stretched at a rate of 200 mm/min using a tensile tester to measure tensile strength and breaking elongation. The test sample having a retention of tensile strength falling in a range of 70% to 130% and a retention of breaking elongation falling in a range of 60% to 140% based on the results of the initial tensile test was evaluated as “Pass”.

### [Low-Temperature Characteristics]

Both the insulated electric wire and the cable were allowed to stand in an atmosphere of −40° C. for 16 hours, and then, in the same atmosphere, wound 6 times around a mandrel having a diameter of 10 times that of each of the cable and the electric wire. When no crack occurred, each of the cable and the wire was evaluated as “Pass”.

### [Injury Resistance Test]

The insulated electric wire was allowed to stand in an atmosphere of 135° C. for 1 hour, and then a sharp edge at 90° C. was pushed on the wire with a load of 500 g while electric power was supplied to the wire. When no short-circuiting occurred for 10 minutes, the wire was evaluated as “Pass” (penetration test). The cable was subjected to a dynamic cut-through test according to EN50305-5. 6 to determine “Pass” or “Fail”.

### [Tear Test]

The materials shown in Table 1 or 4 were kneaded with a 6-inch open roll and then pressed at 180° C. for 3 minutes to form a sheet having a thickness of 1 mm. The formed sheet was cross-linked by irradiation with electron beams of 70 kGy and then subjected to a tear test described in JIS C3315-6. 12. The sheet having a tear strength of 250 N/cm or more and an elongation of 15 mm or more was evaluated as “Pass”.

### [Flame Retardant Test]

Both the insulated electric wire and the cable were subjected to a vertical firing test according to EN60332-1-2 to determine “Pass” or “Fail”.

### [Bleed-Out Test]

Each of the insulated electric wire and the cable was wrapped with an aluminum foil and allowed to stand in an atmosphere of 80° C. for 2 weeks to determine the occurrence of bleed-out by visual observation. When no bleed-out occurred, each of the wire and the cable was evaluated as “Pass”.

The test results of the examples and the comparative examples are shown in Tables 5 and 6.

TABLE 5

| | Example 1 | Example 2 | Example 3 | Example 4 | Example 5 | Example 6 | Example 7 | Example 8 | Example 9 |
|---|---|---|---|---|---|---|---|---|---|
| Initial tensile | 11.2 | 12.3 | 18.3 | 19.3 | 18.2 | 17.5 | 18.5 | 15.1 | 15 |
| strength (MPa) | | | | | | | | | |
| Initial tensile | 280 | 227 | 170 | 150 | 160 | 150 | 180 | 183 | 160 |
| elongation (%) | | | | | | | | | |
| Oil resistance | Pass | Pass | Pass | Pass | Pass | Pass | Pass | Pass | Pass |
| test | | | | | | | | | |
| Fuel resistance | Pass | Pass | Pass | Pass | Pass | Pass | Pass | Pass | Pass |
| test | | | | | | | | | |
| Low-temperature | Pass | Pass | Pass | Pass | Pass | Pass | Pass | Pass | Pass |
| characteristic test | | | | | | | | | |
| Injury resistance | Pass | Pass | Pass | Pass | Pass | Pass | Pass | Pass | Pass |
| test | | | | | | | | | |
| Tear test | Pass | Pass | Pass | Pass | Pass | Pass | Pass | Pass | Pass |
| Flame retardancy | Pass | Pass | Pass | Pass | Pass | Pass | Pass | Pass | Pass |
| test | | | | | | | | | |
| Bleed-out test | Pass | Pass | Pass | Pass | Pass | Pass | Pass | Pass | Pass |
| Total pass/fail | Pass | Pass | Pass | Pass | Pass | Pass | Pass | Pass | Pass |
| determination | | | | | | | | | |

TABLE 6

| | | | | | | | | | | Comp. |
|---|---|---|---|---|---|---|---|---|---|---|
| | Comp. | Comp. | Comp. | Comp. | Comp. | Comp. | Comp. | Comp. | Comp. | Example |
| | Example 1 | Example 2 | Example 3 | Example 4 | Example 5 | Example 6 | Example 7 | Example 8 | Example 9 | 10 |
| Initial tensile | 23.3 | 15.5 | 18.6 | 19.5 | 13.2 | 15.2 | 16.3 | 12.2 | 12.2 | 13.5 |
| strength (MPa) | | | | | | | | | | |
| Initial tensile | 70 | 170 | 120 | 130 | 230 | 180 | 250 | 100 | 250 | 140 |
| elongation (%) | | | | | | | | | | |
| Oil resistance | Pass | Fail | Pass | Pass | Pass | Pass | Pass | Pass | Pass | Pass |
| test | | | | | | | | | | |
| Fuel resistance | Pass | Fail | Pass | Pass | Pass | Pass | Pass | Pass | Pass | Pass |
| test | | | | | | | | | | |
| Low-temperature | Pass | Pass | Fail | Pass | Fail | Pass | Pass | Pass | Pass | Pass |
| characteristic test | | | | | | | | | | |
| Injury resistance | Pass | Fail | Pass | Pass | Pass | Pass | Pass | Pass | Pass | Pass |
| test | | | | | | | | | | |
| Tear test | Pass | Pass | Fail | Fail | Pass | Fail | Pass | Pass | Pass | Pass |
| Flame retardancy | Pass | Pass | Pass | Pass | Pass | Pass | Fail | Pass | Fail | Pass |
| test | | | | | | | | | | |
| Bleed-out test | Pass | Pass | Pass | Fail | Pass | Pass | Pass | Pass | Pass | Pass |
| Total pass/fail | Fail | Fail | Fail | Fail | Fail | Fail | Fail | Fail | Fail | Fail |
| determination | | | | | | | | | | |

Table 5 indicates that the insulated electric wire and the cable using each of the halogen-free flame-retardant polymer compositions of Examples 1 to 9 are a halogen-free flame-retardant insulated electric wire and cable having high flame retardancy and excellent oil resistance/fuel resistance, low-temperature characteristics, and injury resistance.

On the other hand, Comparative Example 1 used HDPE as the base polymer and was thus evaluated as “Fail” in terms of initial elongation. Comparative Example 2 used LLDPE at a low ratio and was thus evaluated as “Fail” in terms of oil resistance/fuel resistance and also evaluated as “Fail” in terms of injury resistance. Comparative Example 3 used PE at a high ratio and was thus evaluated as “Fail” in terms of initial elongation due to unsatisfactory dispersion of magnesium hydroxide. Further, Comparative Example 3 was evaluated as “Fail” in terms of low-temperature characteristics and tear resistance. Comparative Example 4 used a small amount of EVA wax and thus showed unsatisfactory tear resistance and was evaluated as “Fail” in terms of initial elongation. In addition, blooming occurred in the bleed-out test. Comparative Example 5 contained maleic acid-modified polyolefin at a low ratio and did not satisfy the low-temperature characteristics and produced a crack in the test. Comparative Example 6 contained EVA wax, but was evaluated as “Fail” in terms of tear resistance because the wax did not satisfactorily function. Comparative Example 7 was short of amount of magnesium hydroxide and was thus evaluated as “Fail” in terms of flame retardancy. Conversely, Comparative Example 8 contained magnesium hydroxide in an excessive amount and was thus evaluated as “Fail” in terms of initial elongation. Comparative Example 9 contained a sufficient amount of magnesium hydroxide but a small amount of carbon black, and was thus evaluated as “Fail” in terms of flame retardancy. Comparative Example 10 contained a large amount of carbon black and was thus evaluated as “Fail” in terms of initial elongation because of strong interaction with the polymer.

What is claimed is:

1. A halogen-free flame-retardant polymer composition comprising:
a base polymer containing 60% to 70% by mass of linear low-density polyethylene (LLDPE), 10% by mass or more of ethylene-vinyl acetate (EVA) having a melt flow rate (MFR) of 100 or more, and 10% to 20% by mass of maleic acid-modified polyolefin;
a metal hydroxide added at a ratio of 150 to 220 parts by mass relative to 100 parts by mass of the base polymer; and
carbon black,
wherein an addition ratio (metal hydroxide/carbon black) between the metal hydroxide and the carbon black is 15:1 to 100:1.

2. The halogen-free flame-retardant polymer composition according to claim 1, wherein the LLDPE has a MFR of 1.0 to 1.5 and a density of 0.915 g/cm³ to 0.923 g/cm³.

3. An insulated electric wire comprising:
a conductor; and
an insulating layer formed on a periphery of the conductor and comprising the halogen-free flame-retardant polymer composition according to claim 1.

4. A cable comprising:
a conductor;
an insulating layer formed on the periphery of the conductor; and
a sheath formed on the periphery of the insulating layer and comprises the halogen-free flame-retardant polymer composition according to claim 1.
